(19) United States
(12) Patent Application Publication
(10) Pub. No.: US 2026/0196210 A1
(43) Pub. Date: Jul. 9, 2026

(54) SPOKEN LANGUAGE UNDERSTANDING USING MACHINE LEARNING

(71) Applicant: Google LLC, Mountain View, CA (US)

(72) Inventors: Aren Jansen, Mountain View, CA (US); Ryan M. Rifkin, Oakland, CA (US); Daniel Patrick Whittlesey Ellis, New York, NY (US)

(21) Appl. No.: 18/868,506

(22) PCT Filed: Jun. 2, 2022
(86) PCT No.: PCT/US2022/032017

§ 371 Date: Nov. 22, 2024

(51) Int. Cl. G10L 15/16; G10L 15/06

(52) U.S. Cl. CPC G10L 15/16; G10L 15/063

(57) ABSTRACT

Methods, systems, and apparatus, including computer programs encoded on computer storage media, for generating embeddings of spoken utterances. One of the methods includes obtaining audio data representing a spoken utterance; processing the audio data using an encoder neural network to generate an embedding of the spoken utterance; and processing the embedding of the spoken utterance using a prediction neural network to generate a prediction about the spoken utterance, the processing comprising: maintaining respective embeddings for a plurality of preceding spoken utterances; determining one or more embeddings of respective preceding spoken utterances that are relevant to generating the prediction about the spoken utterance; and processing (i) the embedding of the spoken utterance and (ii) the respective embeddings of the one or more determined preceding spoken utterances to generate the prediction about the spoken utterance.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes systems implemented as computer programs on one or more computers in one or more locations that are configured to execute an encoder neural network that processes data representing a spoken utterance and generates an embedding of the spoken utterance. The embedding of the spoken utterance can then be processed, e.g., by a prediction neural network, to generate a prediction about the spoken utterance.

In this specification, a spoken utterance is a sequence of one or more words and/or nonlinguistic vocalizations (e.g., cries, moans, or laughter) spoken by a single speaker. A spoken utterance can represent a cohesive statement of the speaker, e.g., one “turn” of the speaker during a conversation. For example, the spoken utterance can include one or more uninterrupted sentences spoken by the speaker. In some cases, a spoken utterance is synthetic, i.e., has been generated by a computer system, e.g., a trained audio synthesis machine learning system, that is configured to emulate human speech.

The embedding of the spoken utterance can encode both lexical features of the spoken utterance and paralinguistic features of the spoken utterance. In this specification, a lexical feature of a spoken utterance relates to the content of the spoken utterance, i.e., the meaning of the words spoken in the utterance. A paralinguistic feature of a spoken utterance relates to meaning that is communicated by the manner in which the utterance was spoken. For example, paralinguistic features can represent the prosody, pitch, volume, accent, or intonation of the speaker when delivering the spoken utterance.

In some implementations described in this specification, the system stores embeddings of multiple preceding spoken utterances that were previously processed by the system, and uses both the embedding of the current spoken utterance and respective embeddings of one or more preceding spoken utterances to generate the prediction about the current spoken utterance. For instance, the system can store, for each of one or more preceding spoken utterances, the embedding of the preceding spoken utterance generated directly by the encoder neural network. Instead or in addition, the system can store, for each of one or more preceding spoken utterances, an aggregated embedding that has a lower dimensionality than the embedding generated by the encoder neural network.

The subject matter described in this specification can be implemented in particular embodiments so as to realize one or more of the following advantages.

Using techniques described in this specification, a system can generate a single embedding of a spoken utterance that encodes both the lexical meaning of the spoken utterance and additional paralinguistic information from the spoken utterance, e.g., information related to the emotion or truthfulness of the speaker who spoke the utterance. Some existing systems generate embeddings that only encode the lexical meaning of spoken language, and lack any paralinguistic context, which can significantly reduce the usefulness of the embedding for downstream tasks because the paralinguistic context can fundamentally change the meaning of a statement (e.g., if the statement was spoken in a sarcastic manner). Thus, using techniques described in this specification, a system can generate a single embedding of a spoken utterance that can be used for a wide range of different downstream tasks related to the spoken utterance, i.e., that can be used to generate a wide range high-quality predictions about the spoken utterance.

Some existing systems configured to generate embeddings of spoken language by first processing audio data representing the spoken language using an automatic speech recognition (ASR) system to generate a transcription, and then processing the transcription to generate the embedding.

Using techniques described in this specification, a system can generate an embedding of a spoken utterance without explicitly generating a transcription of the spoken utterance. That is, can perform “end-to-end” spoken language understanding without chaining an ASR system with a natural language understanding system. Thus, the systems described herein can achieve better performance because they do not rely on an ASR system that may generate inaccurate transcriptions. Furthermore, the systems described herein can enjoy better efficiency because they can generate an embedding of a spoken utterance directly from audio data representing the spoken utterance, instead of requiring a two-step process with ASR that requires additional time and computational resources.

Using techniques described in this specification, a system can leverage information encoded in embeddings of preceding spoken utterances when generating predictions about a new spoken utterance. That is, the system can perform “longitudinal” spoken language understanding using a memory of historical embeddings. By leveraging historical embeddings, the system can significantly improve the quality of the predictions about the new spoken utterance. Paralinguistic features of spoken utterances can be subtle and highly speaker-specific; e.g., different speakers can express the same emotion in a different way. Thus, having access to a history of utterances spoken by the same speaker can allow the system to accurately identify the paralinguistic features of the speech of that particular speaker, and thus can encode significantly more information in the embeddings of the spoken utterances. Some existing systems analyze spoken language in isolation, and thus ignore the additional information that can be gained from historical context.

Some existing systems configured to perform text processing tasks using a history of text data. Text data generally has a lower memory footprint than audio data; e.g., a sentence represented in text can be stored in less memory than the same sentence spoken and recorded as audio data. Systems described in this specification can maintain and leverage a history of audio data to make predictions about new spoken utterances by maintaining a memory bank of preceding spoken utterances. To overcome the obstacles introduced by the density of audio data, the system can execute intelligent maintenance techniques such as pruning and downsampling to improve the efficiency of the system while maintaining a high quality of predictions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example neural network system for generating predictions about spoken utterances.

FIG. 2 is a diagram of an example neural network system that includes a memory bank configured to store utterance embeddings.

FIG. 3 is a diagram of an example neural network system that includes multiple memory banks configured to store utterance embeddings.

FIG. 4 is a flow diagram of an example process for generating a prediction for a spoken utterance.

Like reference numbers and designations in the various drawings indicate like elements.

### DETAILED DESCRIPTION

This specification describes a system implemented as computer programs on one or more computers in one or more locations that is configured to generate embeddings for spoken utterances, and use the embeddings to generate predictions about the spoken utterances.

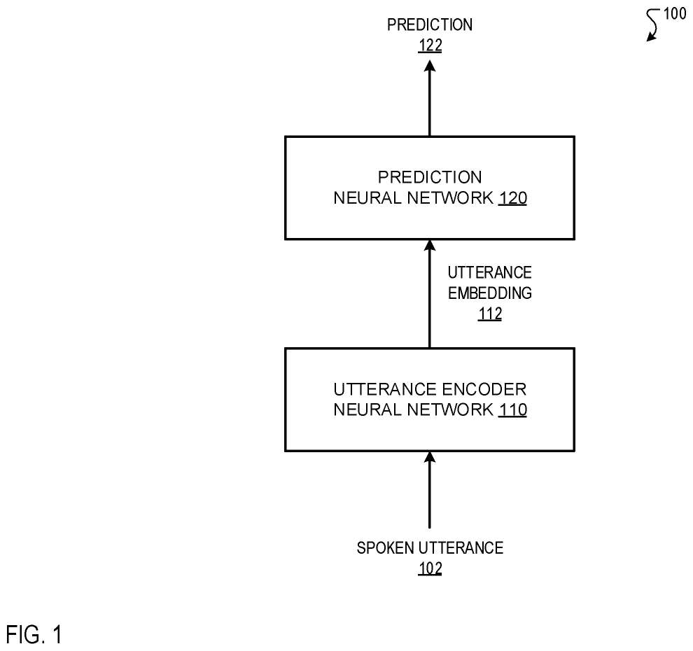

FIG. 1 is a diagram of an example neural network system 100 for generating predictions about spoken utterances. The neural network system 100 is an example of a system implemented as computer programs on one or more computers in one or more locations, in which the systems, components, and techniques described below can be implemented.

The neural network system is configured to process data representing a spoken utterance 102 and to generate a prediction 122 about the spoken utterance 102. The spoken utterance 102 can be represented in any appropriate way. For example, the spoken utterance 102 can be represented by audio data that includes a sequence of data elements representing the audio signal of the spoken utterance 102, e.g., where each data element represents a raw, compressed, or companded amplitude value of an audio wave of the spoken utterance 102. As another example, the spoken utterance can be represented using a spectral representation, e.g., a spectrogram or a mel-frequency cepstral coefficient (MFCC) feature representation generated from raw audio data of the spoken utterance 102.

The neural network system 100 includes an utterance encoder neural network 110 and a prediction neural network 120. The utterance encoder neural network 110 is configured to process the spoken utterance 102 and to generate an embedding 112 of the spoken utterance 102. The prediction neural network 120 is configured to process the embedding 112 of the utterance 102 and to generate the prediction 122 about the utterance 102. In this specification, an embedding is an ordered collection of numeric values that represents an input in a particular embedding space. For example, an embedding can be a vector of floating point or other numeric values that has a fixed dimensionality.

In some implementations, the neural network system 100 includes multiple prediction neural networks 120 that are each configured to process the utterance embedding 112 and to generate a respective different prediction 122 about the spoken utterance 102, i.e., to perform a respective different machine learning task using the utterance embedding 112. That is, the utterance encoder neural network 110 can be configured through training to generate an utterance embedding 112 that encodes maximal information from the spoken utterance 102, and that can be used for multiple different machine learning tasks.

In some implementations, the utterance encoder neural network 110 and the prediction neural network 120 execute asynchronously. For example, the utterance encoder neural network 110 can generate the utterance embedding 112 at a first time point, and store the utterance embedding 112 in a memory bank. Then, at a later time point, the prediction neural network 120 can obtain the utterance embedding 112 from the memory bank and process the utterance embedding 112 to generate the prediction 122.

In some implementations, the utterance encoder neural network 110 and the prediction neural network 120 are executed by the same device, e.g., an accelerator such as a graphics processing unit (GPU) or a tensor processing unit (TPU). In some other implementations, the utterance encoder neural network 110 and the prediction neural network 120 are executed by respective different devices, e.g., different devices in the same cloud computing environment or respective different cloud computing environments.

The neural network system 100 can be configured to perform any appropriate machine learning task on the spoken utterance 102.

For example, the prediction 122 can represent a predicted text sample that corresponds to the spoken utterance; that is, the neural network system 100 can be configured to perform “speech-to-text.” As another example, the prediction 122 can identify a predicted class of the spoken utterance 102, e.g., an identification of a speaker predicted to have spoken the utterance 102, a prediction of a grammatical mood of the spoken utterance 102 (e.g., whether the spoken utterance 102 is a question, a command, a statement, a joke, and so on), or an identification of an emotion predicted to be exhibited in the spoken utterance 102. As another example, the prediction 122 can represent audio data or text data related to the spoken utterance 102, e.g., audio data or text data representing an answer to a question proposed in the spoken utterance 102. As another example, in implementations in which the spoken utterance 102 is a synthetic spoken utterance, the prediction 122 can be a prediction of the naturalness or appropriateness of the synthetic spoken utterance; e.g., if the synthetic spoken utterance represents a single “turn” in a conversation or audiobook, then the prediction 122 can identify a predicted extent to which the synthetic spoken utterance has an appropriate style and/or prosody. As another example, the prediction 122 can be a prediction of the intended recipient of the spoken utterance 122, e.g., a prediction of whether the spoken utterance 122 was directed to an assistant device such as a mobile device or smart speaker, or to another human.

The utterance encoder neural network 110 can include one or more neural network layers of any appropriate type. For example, the utterance encoder neural network 110 can include one or more convolutional neural network layers that are configured to apply a one-dimensional convolutional kernel to a sequence representing the spoken utterance 102 (or an intermediate representation of the spoken utterance), e.g., a sequence of amplitude values or spectral frames. Instead or in addition, the utterance encoder neural network 110 can include one or more self-attention neural network layers that are configured to apply a self-attention mechanism to a sequence representing the spoken utterance 102 (or an intermediate representation of the spoken utterance 102). Instead or in addition, the utterance encoder neural network 110 can include one or more feedforward neural network layers and/or one or more recurrent neural network layers.

The utterance embedding 112 can have any appropriate format. For example, the utterance embedding 112 can be a fixed-size tensor, i.e., a tensor that has a predetermined dimensionality regardless of the length or other attributes of the spoken utterance 102. As another example, the utterance embedding 112 can be represented by a sequence of elements (sometimes called “embedding elements” in this specification); e.g., the utterance embedding 112 can be a time-series representation that includes a sequence of embedding elements that each correspond to one or more elements of the spoken utterance 102. In these implementations, the number of embedding elements of the utterance embedding 112 can change according to the length of the spoken utterance 102; e.g., if the spoken utterance 102 is represented by a sequence of N elements, the utterance embedding 112 can be represented by a sequence of N embedding elements.

The utterance encoder neural network 110 can be configured through training to generate an utterance embedding 112 that encodes both lexical features of the spoken utterance 102 and paralinguistic features of the spoken utterance 102. Example techniques for training the utterance encoder neural network 110 are described in more detail below.

In some implementations, the utterance encoder neural network 110 generates the utterance embedding 112 without explicitly generating a transcription of the spoken utterance 102. That is, the utterance encoder neural network 110 can encode the lexical meaning of the spoken utterance 102 into the utterance embedding 112 even though the network 110 does not have access to a transcription of the spoken utterance 102.

In some implementations, the utterance encoder neural network 110 is configured to process one or more auxiliary inputs in addition to the spoken utterance that provide context for the spoken utterance 102. For example, if the spoken utterance 102 comes from audio data associated with a video (e.g., if the spoken utterance 102 was captured by the camera that captured the video), then the utterance encoder neural network 110 can be configured to process one or more video frames from the video. The utterance encoder neural network 110 can use the auxiliary inputs to encode additional information into the utterance embedding 112, improving the quality of the prediction 122.

The prediction neural network 120 can include one or more neural network layers of any appropriate type. For example, the prediction neural network 120 can include one or more convolutional neural network layers that are configured to apply a one-dimensional convolutional kernel to a sequence representing the utterance embedding 112 (or an intermediate representation of the utterance embedding 112). Instead or in addition, the prediction neural network 120 can include one or more self-attention neural network layers that are configured to apply a self-attention mechanism to a sequence representing the utterance embedding 112 (or an intermediate representation of the utterance embedding 112). Instead or in addition, the prediction neural network 120 can include one or more feedforward neural network layers and/or one or more recurrent neural network layers.

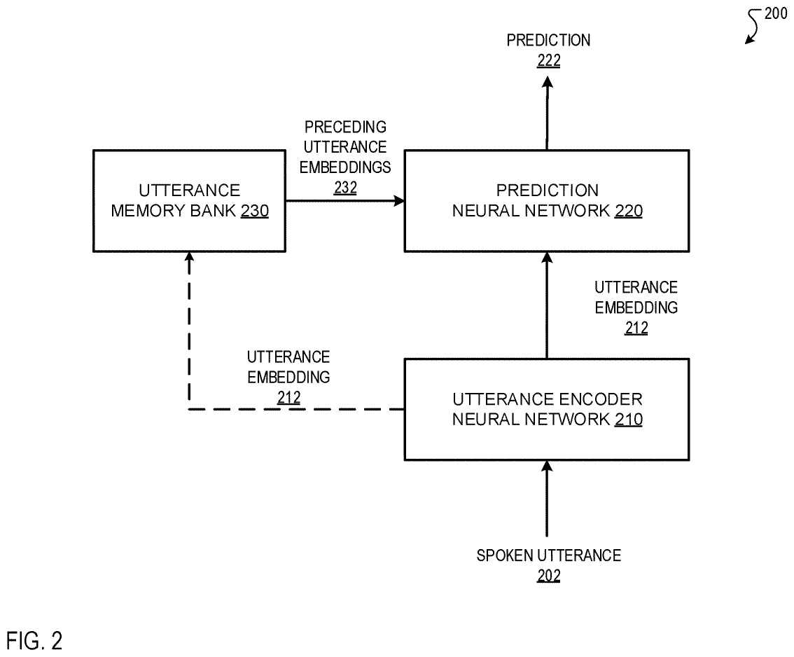

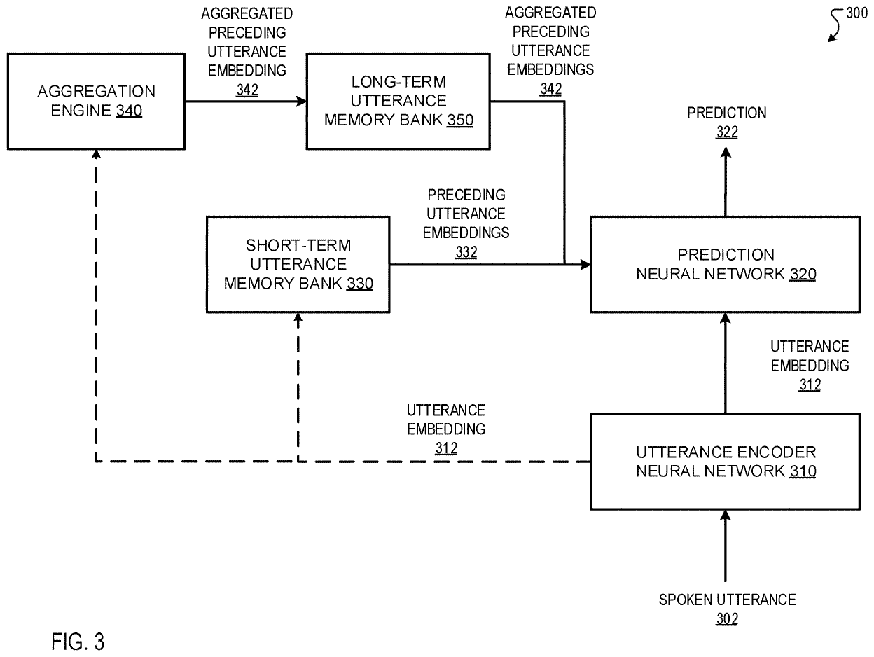

In some implementations, as described in more detail below with reference to FIG. 2 and FIG. 3, the prediction neural network 120 obtains respective embeddings of preceding spoken utterances previously processed by the neural network system 100, and processes the utterance embedding 112 and the respective embeddings of the preceding spoken utterances to generate the prediction 122.

The utterance encoder neural network 110 and the prediction neural network 120 can be trained concurrently. For example, a training system can determine an error in the prediction 122 and backpropagate the error through both the utterance encoder neural network 110 and the prediction neural network 120 to determine an update to the parameters of the respective networks 110 and 120, e.g., using stochastic gradient descent.

In some implementations, the utterance encoder neural network 110 is pre-trained before training of the prediction neural network 120. For example, a training system can execute a self-supervised training technique to determine values for the parameters of the utterance encoder neural network 110.

For example, the training system can train the utterance encoder neural network 110 using a reconstruction task, where the training system attempts to reconstruct the original spoken utterance 102 (or another representation of the spoken utterance 102, e.g., an output of an early neural network layer in the utterance encoder neural network 110) from the utterance embedding 112, and update the parameters of the utterance encoder neural network 110 according to a difference between the original spoken utterance 102 and the reconstruction.

Instead or in addition, the training system can execute a contrastive learning technique that generates parameter updates to the utterance encoder neural network 110 according to predicted similarities between pairs of spoken utterances in a training set of spoken utterances. A contrastive loss function can be a function of both the generated utterance embedding 112 and one or more other utterances (e.g., utterances preceding or following the spoken utterance 102 in a conversation, or utterances obtained from a memory bank as described below with reference to FIG. 2 and FIG. 3).

Instead or in addition, the training system can execute a knowledge distillation technique by training the utterance encoder neural network 110 to generate utterance embeddings 112 that match the outputs generated by another machine learning model. That is, the training system can process a training spoken utterance using the other machine learning model, called a “teacher” machine learning model, to generate a ground-truth embedding of the training spoken utterance, and then update the parameters of the utterance encoder neural network 110 according to a difference between the ground-truth embedding and an utterance embedding 112 generated by the utterance encoder neural network 110 in response to processing the training spoken utterance. For example, the teacher machine learning model can include an ASR model that is configured to generate a transcription of the training spoken utterance, followed by a natural language model (e.g., a self-attention based neural network) that is configured to process the transcription to generate an embedding of the transcription. Thus, the utterance encoder neural network 110 can be trained to generate utterance embeddings 112 that encode the lexical meaning of spoken utterances 102 without using a transcription of the spoken utterances 102.

After pre-training the utterance encoder neural network 110, the training system can fine-tune the parameters (i.e., further update the values of the parameters) of the utterance encoder neural network 110 during training of the prediction neural network 120, as described above.

In some other implementations, the utterance encoder neural network 110 and the prediction neural network 120 are trained separately. For example, a training system can determined trained values for the parameters of the utterance encoder neural network 110 as described above, and then “freeze” the trained values (i.e., not update the trained values) when training the prediction neural network 120 using utterance embeddings 112 generated by the utterance encoder neural network.

After training, the neural network system 100 can be deployed in any appropriate inference environment, wherein the neural network system 100 can receive new spoken utterances 102 and generate predictions 122 about the new spoken utterances 102. For example, the neural network system 100 can be deployed in a cloud environment, or on a user device such as a laptop, mobile phone, or tablet.

FIG. 2 is a diagram of an example neural network system 200 that includes a memory bank configured to store utterance embeddings. The neural network system 200 is an example of a system implemented as computer programs on one or more computers in one or more locations, in which the systems, components, and techniques described below can be implemented.

The neural network system 200 is configured to process data representing a spoken utterance 202 and to generate a prediction 222 about the spoken utterance 202. The neural network system 200 includes an utterance encoder neural network 210, a prediction neural network 220, and an utterance memory bank 230.

The utterance encoder neural network 210 is configured to process the spoken utterance 202 and to generate an embedding 212 of the spoken utterance 202. For example, the utterance encoder neural network 210 can be configured similarly to the utterance encoder neural network 110 described above with reference to FIG. 1.

The utterance memory bank 230 is configured to maintain, for each of one or more spoken utterances previously processed by the neural network system 200 (called “preceding” spoken utterances in this specification), the utterance embedding 212 generated by the utterance encoder neural network 210 in response to processing the preceding spoken utterance (and/or another embedding generated from the utterance embedding 212 for the preceding spoken utterance, as described in more detail below). For example, the utterance memory bank 230 can maintain hundreds, thousands, or hundreds of thousands of embeddings. The embeddings of preceding spoken utterances stored by the utterance memory bank 230 are referred to as preceding utterance embeddings 232.

The prediction neural network 220 is configured to process the embedding 212 of the utterance 202 to generate the prediction 222 about the utterance 202. To generate the prediction 222, the prediction neural network 220 can obtain one or more preceding utterance embeddings 232 corresponding to respective preceding spoken utterances from the utterance memory bank 230. The prediction neural network 220 can then process (i) the utterance embedding 212 of the spoken utterance 202 and (ii) the preceding utterance embeddings 232 of the respective preceding spoken utterances to generate the prediction 222.

The preceding utterance embeddings 232 can provide additional information for generated the prediction 222 about the spoken utterance 202. In many situations, a spoken utterance 202 evaluated in isolation is insufficient to generate high-quality predictions 222 about respective spoken utterances 202 (e.g., predictions 222 that have a high accuracy, recall, and/or precision). For example, because many speakers express the same emotion in a different manner, if the prediction neural network 220 is configured to generate a prediction 222 of an emotion or veracity of the spoken utterance 202, then only processing the embedding 212 of the spoken utterance 202 without any other information about the speaker can inhibit the quality of the prediction 222. However, if the prediction neural network 220 has access to preceding utterance embeddings 232 representing spoken utterances by the same speaker, then the prediction neural network 220 can leverage the additional context provided by the preceding utterance embeddings 232 to improve the accuracy of the prediction 222.

In some implementations, the neural network system 200 can be deployed in an inference environment in which it receives new spoken utterances 202 that have each been captured in the same particular context. For example, each new spoken utterances 202 can be spoken by the same speaker, spoken in the same physical location such as a particular building or a particular room of a building, or captured by the same recording device. Thus, the neural network system 200 can collect preceding utterance embeddings 232 that provide more information about the particular context in which the system 200 is deployed. The prediction neural network 220 can thus leverage the preceding utterance embeddings 232 to adapt the predictions 222 for the particular context, improving the quality of the predictions 222.

To generate the prediction 222 for the spoken utterance 202, the neural network system 200 can identify one or more particular preceding utterance embeddings 232 stored in the utterance memory bank 230 that are relevant to the prediction 222.

In this specification, a preceding utterance embedding is relevant to a prediction about a new utterance embedding generated by a prediction neural network (or, equivalently, relevant to the generation of a prediction about the new utterance embedding by the prediction neural network) if the preceding utterance embedding encodes information that can be used by the prediction neural network to generate a prediction that has a higher likelihood of being correct. For example, a preceding utterance embedding corresponding to a preceding utterance spoken by the same speaker as a particular utterance, in the same location as the particular utterance, and/or regarding the same subject or otherwise sharing a similar content with the particular utterance can encode information (extracted from the audio data representing the preceding utterance) that is useful for a prediction about the particular utterance; therefore the preceding utterance embedding can be determined to be relevant for the prediction.

For example, the neural network system 200 can determine a similarity between (i) each preceding utterance embedding 232 stored by the utterance memory bank 230 and (ii) the utterance embedding 212 (or an intermediate representation of the utterance embedding 212 generated by the prediction neural network 220). As a particular example, the neural network system 200 can generate a similarity score for each preceding utterance embedding 232, e.g., by determining the product between the preceding utterance embedding 232 and the utterance embedding 212. As another particular example, the neural network system 200 can determine a distance between each preceding utterance embedding 232 and the utterance embedding 212, e.g., using Euclidean distance or cosine similarity. In other words, the similarity score or distance computed for a preceding utterance embedding 232 can be a measure of relevance for the prediction 222.

In some implementations, the neural network system 200 executes an approximation technique to determine the preceding utterance embeddings 232 with the highest similarity scores (or equivalently lowest distances), e.g., an approximate nearest neighbors technique.

The neural network system 200 can then provide the preceding spoken utterance embeddings 232 identified to have the highest similarity scores (or lowest distances) to the prediction neural network 220. For example, the neural network system 200 can provide the N preceding utterance embeddings 232 with the highest similarity scores, or any preceding utterance embedding 232 with a similarity score that satisfies a predetermined threshold.

As another example, the prediction neural network 220 can execute an attention mechanism to identify the one or more preceding utterance embeddings 232 that are relevant to the prediction 222. The prediction neural network 220 can generate (i) one or more queries from the utterance embedding 212 and (ii) for each preceding utterance embedding 232, one or more keys from the preceding utterance embedding 232.

For example, if the utterance memory bank 230 stores the preceding utterance embeddings 232 as a sequence of elements (e.g., if the utterance memory bank 230 stores the utterance embeddings generated directly by the utterance encoder neural network 210 without any aggregation, as described in more detail below), then for each preceding utterance embedding 232, the prediction neural network 220 can generate a respective key for each element in the sequence of the preceding utterance embedding 232. Similarly, if the utterance embedding 212 (or the intermediate representation) is represented as a sequence of elements, then the prediction neural network 220 can generate a respective query for each element in the sequence. Then, for a particular preceding utterance embedding 232 stored by the utterance memory bank 230, and for each pair of (i) a key generated from an element of the preceding utterance embedding 232 and (ii) a query generated from the utterance embedding 212, the prediction neural network 220 can combine the key and query to generate an attention value. The prediction neural network 220 can then combine, across all keys generated from the preceding utterance embedding 232 and all queries generated from the utterance embedding 212, the respective attention values to generate a similarity score, e.g., by determining a sum of the attention values or a magnitude of a vector whose elements are the attention values.

As another example, if the utterance memory bank 230 stores the preceding utterance embeddings 232 as a single tensor (e.g., an aggregation of respective elements, as described in more detail below), then for each preceding utterance embedding 232, the prediction neural network 220 can generate a single key. Alternatively, if the utterance memory bank 230 stores the preceding utterance embeddings 232 as a sequence of elements, the prediction neural network 220 can aggregate the elements into a single tensor and generate a single key from the aggregated tensor, e.g., improving the computational efficiency of the neural network system 200. Then, for a particular preceding utterance embedding 232 stored by the utterance memory bank 230, and for each query generated from the utterance embedding 212, the prediction neural network 220 can combine the key for the preceding utterance embedding 232 and query to generate an attention value. The prediction neural network 220 can then combine, across all queries generated from the utterance embedding 212, the respective attention values to generate a similarity score, e.g., by determining a sum of the attention values or a magnitude of a vector whose elements are the attention values.

As another example, the prediction neural network 220 can aggregate the elements of the utterance embedding 212 to generate a single aggregated tensor (or, in some implementations, the utterance embedding 212 can itself already be represented as a single tensor), and determine attention values between the aggregated tensor and respective preceding utterance embeddings 232 and use the attention values as similarity scores. As a particular example, if each preceding utterance embedding 232 are represented as single aggregated tensors, then the prediction neural network 220 can generate a single attention value between the aggregated tensor of the utterance embedding 212 and the aggregated tensor of the preceding utterance embedding 232. As another particular example, if each preceding utterance embedding 232 includes a sequence of elements, then the prediction neural network 220 can generate a respective attention value between the aggregated tensor of the utterance embedding 212 and each element of the preceding utterance embedding 232, and combine the attention values as described above to generate a similarity score.

In other words, the attention values computed for a preceding utterance embedding 232 can be a measure of relevance for the prediction 222.

In some implementations, instead of or in addition to obtaining preceding utterance embeddings 232 that are determined to be similar to the entire utterance embedding 212, the prediction neural network 220 can obtain, for each of one or more individual elements of the utterance embedding 212, one or more preceding utterance embeddings 232 that are determined to be similar to the element. For example, the prediction neural network 220 can generate attention values between the element and respective preceding utterance embeddings 232, as described above, and obtain the preceding utterance embeddings 232 with the largest attention values. Thus, if there is a particular important element of the utterance embedding 212, then the prediction neural network 220 can leverage information encoded in respective preceding utterance embeddings related to the important element; e.g., if an element represents a proper name that was spoken during the utterance 202, then the prediction neural network 220 can obtain preceding utterance embeddings 232 of respective preceding spoken utterances that also included the proper name.

The prediction neural network 220 can obtain any appropriate number of preceding utterance embeddings 232 to generate the prediction 222, e.g., one, five, ten, fifty, or one hundred preceding utterance embedding 232. Typically the prediction neural network 220 obtains a proper subset (e.g., a small proportion, e.g., 1%, 0.01%, or 0.0001%) of the preceding utterance embeddings 232 stored by the utterance memory bank 230. A proper subset (also called a strict subset) of a set is a subset of the set that does not include all of the elements of the set, i.e., includes strictly fewer elements than the set. In some implementations, the prediction neural network 220 obtains a variable number of preceding utterance embeddings 232 (e.g., any preceding utterance embedding 232 with a similarity score that satisfies a predetermined threshold).

The prediction neural network 220 can then determine one or more preceding utterance embeddings 232 whose respective queries are most similar to the keys of the utterance embedding 212, e.g., by determining a product between the query and the key or by performing an approximate nearest neighbors technique.

After obtaining the one or more relevant preceding utterance embeddings 232 from the utterance memory bank 230, the prediction neural network 220 can process the obtained preceding utterance embeddings 232 to generate the prediction 222. For example, the prediction neural network 220 can execute an attention mechanism between (i) the utterance embedding 212 (or an intermediate representation of the utterance embedding 212 generated by the prediction neural network 220) and (ii) the preceding utterance embeddings 232.

For example, the prediction neural network 200 can apply a cross-attention mechanism between the utterance embedding 212 (at any appropriate resolution, e.g., as a sequence of elements or a single aggregated tensor, as described above) and the preceding utterance embeddings 232 (at any appropriate resolution, e.g., as a sequence of elements or a single aggregated tensor, as described above).

As a particular example, the prediction neural network 220 can apply cross-attention by: for each preceding utterance embedding 232, generating one or more queries for the preceding utterance embedding 232 (e.g., using a trained query neural network layer); generating one or more keys and one or more values for the utterance embedding 212 (e.g., using a trained key neural network layer and a trained value neural network layer); and mapping the queries with the keys and values to update the utterance embedding 212 (e.g., by combining the queries and keys to generate respective weights and computing a weighted sum of the values using the generated weights).

As another particular example, as described above, in some implementations the prediction neural network 220 selected the preceding utterance embeddings 232 by computing attention values for the preceding utterance embeddings 232 from (i) queries generated from the utterance embedding 212 and (ii) keys generated from the preceding utterance embeddings 232. In some such implementations, the prediction neural network can leverage these attention values to update the utterance embedding 212 by (i) generating one or more values from the utterance embedding 212, e.g., values generated during a separate self-attention mechanism applied to the utterance embedding 212, and (ii) combining the generated values with the attention values to update the utterance embedding 212.

In some implementations, the neural network system 200 executes one or more techniques for managing the size of the utterance memory bank 230, to ensure that executing the neural network system 200 does not become computationally infeasible. For example, the neural network system 200 may have access to limited memory resources, or limited computational resources to spend searching the utterance memory bank 230 for relevant preceding utterance embeddings 232 as described above.

In some implementations, the neural network system 200 iteratively prunes (i.e., removes) one or more preceding utterance embeddings 232 from the utterance memory bank 230. The neural network system 200 can use any appropriate criteria to select preceding utterance embeddings 232 as candidate for pruning.

For example, the neural network system 200 can select one or more preceding utterance embeddings 232 to prune based on the amount of time that the preceding utterance embeddings 232 have been stored by the utterance memory bank 230. As a particular example, the neural network system 200 can identify each preceding utterance embedding 232 that has been stored by the utterance memory bank 230 for longer than a predetermined threshold amount of time, and remove the identified preceding utterance embeddings 232.

As another example, instead or in addition to pruning based on time, the neural network system 200 can select one or more preceding utterance embeddings 232 to prune based on how often and/or to what degree the preceding utterance embeddings 232 have been determined to be relevant for predictions 222. As a particular example, the utterance memory bank 230 can store, for each preceding utterance embedding 232, a number of instances that the preceding utterance embedding has been selected for processing by the prediction neural network 220 to generate a new prediction. The neural network system 200 can determine to prune the preceding utterance embeddings 232 with the fewest such instances (e.g., below a predetermined threshold number of instances). In other words, the frequency and/or degree to which a preceding utterance embedding 232 has been determined to be relevant for previous predictions 222 can be used as a measure of predicted relevance for future predictions 222.

As another particular example, in implementations in which the neural network system 200 selects relevant preceding utterance embeddings 232 based on an attention mechanism as described above, the utterance memory bank 230 can store, for each preceding utterance embedding 232, a measure of central tendency (e.g., a moving average) of the attention values computed at respective executions of the neural network system 200 for the preceding utterance embedding 232 and respective new utterance embeddings 212. The neural network system 200 can determine to prune the preceding utterance embeddings 232 with the lowest average attention values (e.g., below a predetermined threshold average attention value). Instead or in addition, the neural network system 200 can determine not to prune preceding utterance embeddings 232 with average attention values above a second predetermined threshold average attention value, e.g., even if the preceding utterance embeddings 232 qualify for pruning based on other metrics such as the amount of time they have been stored.

As another particular example, the utterance memory bank 230 can store, for each preceding utterance embedding 232, a maximum attention value computed at respective executions of the neural network system 200 for the preceding utterance embedding 232 and a respective new utterance embedding 212. The neural network system 200 can determine to prune the preceding utterance embeddings 232 with the lowest maximum attention values (e.g., below a predetermined threshold maximum attention value). Instead or in addition, the neural network system 200 can determine not to prune preceding utterance embeddings 232 with maximum attention values above a second predetermined threshold maximum attention value, e.g., even if the preceding utterance embeddings 232 qualify for pruning based on other metrics such as the amount of time they have been stored.

In some implementations, the neural network system 200 aggregates an utterance embedding 212 (i.e., reduces the dimensionality of the utterance embedding 212) before storing it in the utterance memory bank 230. In this specification, an aggregated embedding is an embedding that has been generated from another embedding and that has a lower dimensionality than the other embedding. For example, if the utterance embedding 212 are represented as a sequence of elements, the neural network system 200 can downsample the elements to generate a shorter sequence before storing the downsampled utterance embeddings 212 in the utterance memory bank 230. As a particular example, if the utterance embeddings 212 are represented as a sequence of elements each having dimensionality D, then the neural network system 200 can determine a single D-dimensional downsampled embedding to be stored in the utterance memory bank 230, e.g., by determining the average of the elements in the sequence or by processing the elements in the sequence using a pooling mechanism such as average pooling, max pooling, or global pooling).

In this specification, an utterance embedding that has not been aggregated after generation by the utterance encoder neural network 310 is called a “full” utterance embedding (or an “unaggregated” utterance embedding). That is, the neural network system 200 can either store full utterance embeddings 212 in the utterance memory bank 230, or process the full utterance embeddings 212 to generate aggregated utterance embeddings before placing them into the utterance memory bank 230. Aggregating utterance embeddings is discussed in more detail below with reference to FIG. 3.

In some implementations, instead of or in addition to reducing the dimensionality of the utterance embeddings 212 before storing them in the utterance memory bank 230, the neural network system 200 can iteratively reduce the dimensionality of the preceding utterance embeddings 232 stored in the utterance memory bank 230. For example, after a preceding utterance embedding 232 has been stored in the utterance memory bank 230 for a predetermined amount of time, the neural network system can reduce the dimensionality of the preceding utterance embedding 232 as it is stored in the utterance memory bank 230, e.g., by downsampling the elements in the preceding utterance embedding 232 as described above. Then, after the downsampled preceding utterance embedding 232 has been stored in the utterance memory bank 230 for a second predetermined amount of time (e.g., the same predetermined amount of time), the neural network system 200 can again downsample the preceding utterance embedding 232. As a particular example, iteratively halve the number of elements in the preceding utterance embedding 232. Instead or in addition to downsampling based on time, the neural network system 200 can downsample the preceding utterance embeddings 232 based on their attention values, as described above.

In some other implementations, as described in more detail below with reference to FIG. 3, the neural network system 200 can maintain multiple different utterance memory banks that store preceding utterance embeddings 232 as respective different resolutions (i.e., having respective different dimensionalities).

In some implementations, the utterance memory bank 230 maintains data representing a graph that encodes relationships between the preceding utterance embeddings 232. Each node in the graph can represent a respective preceding utterance embedding 232 (or, equivalently, the corresponding preceding utterance), and each edge between two nodes can represent a relationship between the preceding utterances represented by the nodes. For example, respective edges of the graph can represent one or more of: a common speaker between the preceding utterances corresponding to the pair of nodes, a common location where the preceding utterances corresponding to the pair of nodes were recorded, or a common device that recorded the preceding utterances corresponding to the pair of nodes. The neural network system 200 can maintain a set of heuristics for generating the graph, so that when a new preceding utterance embedding 232 is added to the utterance memory bank 230, the neural network system 200 can evaluate the heuristics to incorporate a new node representing the new preceding utterance embedding 232.

In these implementations, when identifying one or more relevant preceding utterance embeddings 232 to process to generate a new prediction 222, the neural network system 200 can leverage the relationships between preceding utterances encoded in the graph to identify the relevant preceding utterance embeddings 232. For example, if the neural network system 200 identifies a first preceding utterance embedding 232 as relevant as described above, then the neural network system 200 can identify one or more second preceding utterance embeddings 232 whose corresponding nodes in the graph are connected by an edge to the node corresponding to the first preceding utterance embedding 232. Because the preceding utterances represented by the second preceding utterance embeddings 232 share a relationship with the preceding utterance represented by the first preceding utterance embedding 232, as codified by the graph, the second preceding utterance embeddings 232 can also be relevant for the new prediction 222. Thus, the prediction neural network 220 can process the first preceding utterance embedding 232 and the second preceding utterance embeddings 232 to generate the new prediction 222. Here, the use of the terms “first” and “second” are used to distinguish the different preceding utterance embeddings 232, and not to imply an ordinal relationship between the embeddings.

In some such implementations, the neural network system 200 can further leverage the relationships encoded in the graph when identifying preceding utterance embeddings 232 to prune from the utterance memory bank 230. For example, if a first preceding utterance embedding 232 is a candidate for pruning (e.g., satisfies one or more of the criteria for pruning discussed above) but the corresponding node in the graph shares an edge with a node representing a highly-relevant second preceding utterance embedding 232 (e.g., if the average or maximum attention value for the second preceding utterance embedding 232 satisfies a predetermined threshold), then the neural network system 200 can determine not to prune the first preceding utterance embedding 232.

In some implementations, the neural network system 200 maintains auxiliary data related to the preceding utterances whose preceding utterance embeddings 232 are stored in the utterance memory bank 230. When obtaining a particular preceding utterance embedding 232 to process for generating the prediction 222, the prediction neural network 220 can also obtain the corresponding auxiliary data, and process the auxiliary data to generate the prediction 222.

For example, the neural network system 200 can maintain respective original audio data representing one or more of the preceding utterances whose preceding utterance embeddings 232 are stored in the utterance memory bank 230. For example, the utterance memory bank 230 can store, for each of the one or more preceding utterance embedding 232, the location of a file that stores the corresponding audio data. The prediction neural network 220 can then obtain the audio data corresponding to a particular preceding utterance embedding 232 and process the audio data to generate the prediction 222.

As another example, the neural network system 200 can maintain, for each of one or more preceding utterance embeddings 232, a ground-truth label and/or predicted label for the machine learning task for which the prediction neural network 220 is configured (and/or one or more other machine learning tasks). For example, after generating a prediction 222 for a spoken utterance, when storing the generated utterance embedding 212 in the utterance memory bank 230 to be used at future executions of the neural network system 200, the neural network system 200 can also store the prediction 222 generated for the spoken utterance (or other data representing the prediction 222). In some such implementations, one or more other prediction neural networks configured to process the utterance embedding to generate respective different predictions can also store the predictions in the utterance memory bank 230. Then, when obtaining the utterance embedding for the spoken utterance (now a preceding utterance embedding 232) for generating a prediction for a new utterance, the prediction neural network 220 can also obtain the stored labels for the preceding utterance embedding 232 to help generate the new prediction.

In some implementations, during training of the utterance encoder neural network 210 (separately or in conjunction with the training of the prediction neural network 220), a training system can backpropagate errors in the prediction 222 through the prediction neural network 220 and to the utterance memory bank 230. The training system can then generate an update to the preceding utterance embeddings 232 based on the backpropagated error, e.g., using stochastic gradient. Thus, the preceding utterance embeddings 232 stored by the utterance memory bank 230 can be ensured to encode the most up-to-date information for generating high-quality predictions. Instead or in addition to updating the preceding utterance embeddings 232, the neural network system 200 can backpropagate the error through the memory bank 230 and to the utterance encoder neural network 210 to generate an update to the parameters of the utterance encoder neural network 210.

FIG. 3 is a diagram of an example neural network system 300 that includes multiple memory banks configured to store utterance embeddings. The neural network system 300 is an example of a system implemented as computer programs on one or more computers in one or more locations, in which the systems, components, and techniques described below can be implemented.

The neural network system 300 is configured to process data representing a spoken utterance 302 and to generate a prediction 322 about the spoken utterance 302. The neural network system 300 includes an utterance encoder neural network 310, a prediction neural network 320, a short-term utterance memory bank 330, and a long-term utterance memory bank 350.

The utterance encoder neural network 310 is configured to process the spoken utterance 302 and to generate an embedding 312 of the spoken utterance 302. For example, the utterance encoder neural network 310 can be configured similarly to the utterance encoder neural network 110 described above with reference to FIG. 1.

The short-term utterance memory bank 330 is configured to maintain a preceding utterance embedding 332 for each of one or more preceding spoken utterances previously processed by the neural network system 300. For example, the preceding utterance embeddings 332 can be the utterance embeddings 312 generated by the utterance encoder neural network 310 in response to processing the respective preceding spoken utterances. As another example, the preceding utterance embeddings 332 can be downsampled versions of the corresponding utterance embeddings 312, as described above with reference to FIG. 2.

The long-term utterance memory bank 350 is configured to maintain, for each of one or more preceding spoken utterance previously processed by the neural network system 300, an aggregated version (called an aggregated preceding utterance embedding 342) of the utterance embedding generated by the utterance encoder neural network 310 in response to processing the preceding spoken utterance. For a particular preceding utterance, the corresponding aggregated preceding utterance embedding 342 stored by the long-term utterance memory bank 350 has a lower-dimensionality than the corresponding preceding utterance embedding 332 stored by the short-term utterance memory bank 330 (even in implementations in which the short-term utterance memory bank 330 itself stores downsampled or otherwise aggregated versions of the corresponding utterance embeddings 312).

In other words, the neural network system 300 maintains embeddings for preceding utterances at respective different resolutions: higher-resolution preceding utterance embeddings 332 in the short-term utterance memory bank 330 and lower-resolution aggregated preceding utterance embedding 342 in the long-term utterance memory bank 350. This hierarchy approximately models how people maintain their personal memories: some memories (e.g., very recent memories) are remembered with high precision, while other memories (e.g., memories from days, months, or years ago) are remembered with lower precision. Thus, this specification refers to the memory bank 330 that stores higher-resolution embeddings as “short-term” (modeling a person's short-term memory) and the memory bank 350 that stores lower-resolution embeddings as “long-term” (modeling a person's long-term memory).

The short-term utterance memory bank 330 and the long-term utterance memory bank 350 can store any appropriate number of preceding utterance embeddings 332 and aggregated preceding utterance embeddings 342, respectively, e.g., hundreds, thousands, or hundreds of thousands of embeddings. In some implementations because the aggregated preceding utterance embeddings 342 have a lower dimensionality than the preceding utterance embeddings 332, the long-term utterance memory bank 350 can store more aggregated preceding utterance embeddings 342 than the short-term memory bank 330 can store preceding utterance embeddings 330.

For example, the aggregated preceding utterance embeddings 342 can be generated by an aggregation engine 340 in response to processing the utterance embeddings 312 generated by the utterance encoder neural network 310. For example, the aggregation engine 340 can process the utterance embeddings 312 using a machine-learned aggregation function, e.g., one or more neural network layers, to generate the aggregated preceding utterance embeddings 342. As another example, in implementations in which the utterance embeddings 312 are represented as a sequence of elements, the aggregation engine 340 can apply a pooling mechanism (e.g., average pooling) to the sequence of elements to generate the corresponding aggregated preceding utterance embedding 342.

In some implementations, the long-term utterance memory bank 350 stores aggregated preceding utterance embeddings 342 that represent multiple different preceding utterances. For example, the aggregation engine 340 can process the respective utterance embeddings 312 corresponding to multiple preceding utterances to generate a single aggregated preceding utterance embedding 342.

The prediction neural network 320 is configured to process the embedding 312 of the spoken utterance 302 and to generate the prediction 322 about the utterance 302.

To generate the prediction 322, the prediction neural network 320 can obtain one or more preceding utterance embeddings 332 corresponding to respective preceding spoken utterances from the short-term utterance memory bank 330. For example, the neural network system 300 can identify one or more preceding utterance embeddings 332 in the short-term utterance memory bank 330 that are relevant for the prediction 322 about the spoken utterance 302, as described above with reference to FIG. 2.

The prediction neural network 320 can further obtain one or more aggregated preceding utterance embeddings 342 corresponding to respective preceding spoken utterances from the long-term utterance memory bank 350. For example, the neural network system 300 can identify one or more aggregated preceding utterance embeddings 342 in the long-term utterance memory bank 350 that are relevant for the prediction 322 about the spoken utterance 302, as described above with reference to FIG. 2.

As described above with reference to FIG. 2, in some implementations the neural network system 300 executes an approximation technique to identify the relevant preceding utterance embeddings 332 and/or the relevant aggregated preceding utterance embeddings 342. In some other implementations, because the aggregated preceding utterance embeddings 342 (and, sometimes, the preceding utterance embeddings 332) have been reduced in dimensionality, the neural network system 300 does not have to use an approximation technique, and instead can use an exact technique, e.g., k-nearest-neighbors. That is, one of the advantages of using the aggregation engine 340 to generate aggregated preceding utterance embeddings 342 with relatively little memory footprint is that the retrieval of the relevant aggregated preceding utterance embeddings 342 is more accurate.

The prediction neural network 320 can obtain any appropriate number of preceding utterance embeddings 332 and aggregated preceding utterance embeddings 342. In some implementations, the prediction neural network 320 obtains the same number of preceding utterance embeddings 332 and aggregated preceding utterance embeddings 342. In some other implementations, the prediction neural network 320 obtains a different number of preceding utterance embeddings 332 and aggregated preceding utterance embeddings 342. For example, because the aggregated preceding utterance embeddings have a lower dimensionality, the prediction neural network 320 can obtain more aggregated preceding utterance embeddings 342 than preceding utterance embeddings 332 (e.g., because of the lower computational cost of processing the aggregated preceding utterance embeddings 342).

The prediction neural network 320 can then process (i) the utterance embedding 312 of the spoken utterance 302, (ii) the preceding utterance embeddings 332 obtained from the short-term utterance memory bank 330, and (iii) the aggregated preceding utterance embeddings 342 obtained from the long-term utterance memory bank 350 to generate the prediction 322.

For example, as described above with reference to FIG. 2, the prediction neural network 320 can apply an attention mechanism between (i) the utterance embedding 312 and (ii) the preceding utterance embeddings 332 and the aggregated preceding utterance embeddings 342. In some implementations, the prediction neural network 320 applies to separate attention mechanisms: a first attention mechanism between the utterance embedding 312 and the preceding utterance embedding 332, and a second attention mechanism between the utterance embedding 312 and the aggregated preceding utterance embeddings 342. In some other implementations, the prediction neural network 320 combines the preceding utterance embeddings 332 and the aggregated preceding utterance embeddings 342 into a single set of preceding embeddings, and applies a single attention mechanism between the utterance embedding 312 and the set of preceding embeddings.

In some implementations, instead of providing a new utterance embedding 312 to both the short-term utterance memory bank 330 and the long-term utterance memory bank 350 (e.g., after being processed by the aggregation engine 340) in response to receiving a new spoken utterance 302, the neural network system 300 can provide the utterance embedding 312 only to the short-term utterance memory bank 330, and it is stored as a preceding utterance embedding 332. Then, after the preceding utterance embedding 332 has been stored in the short-term memory bank 330 for some period of time, the preceding utterance embedding 332 can be removed from the short-term memory bank 330, and a corresponding aggregated preceding utterance embedding 342 added to the long-term utterance memory bank 350. In other words, the neural network system 300 can orchestrate a transfer of utterance embeddings from the short-term memory bank 330 to the long-term memory bank 350 over time. For example, the neural network system 300 can determine to transfer a preceding utterance embedding 332 from the short-term memory bank 330 to the long-term memory bank 350 (after being processed by the aggregation engine 340 to generate the corresponding aggregated preceding utterance embedding 342) according to any one or more of the criteria for pruning discussed above (e.g., based on an amount of time stored in the short-term utterance memory bank 330, the attention values computed for the preceding utterance embedding 332, and so on).

As described above with reference to FIG. 2, in some implementations, the neural network system 300 prunes embeddings stored in the short-term utterance memory bank 330 and/or the long-term utterance memory bank 350, e.g., using any one or more of the pruning criteria discussed above. In some such implementations, the short-term utterance memory bank 330 and the long-term utterance memory bank 350 can have different pruning policies, e.g., the long-term utterance memory bank 350 can execute a pruning policy with higher thresholds that allows more aggregated preceding utterances 342 to remain in the long-term utterance memory bank 350 because the aggregated preceding utterances 342 have a relatively small memory footprint.

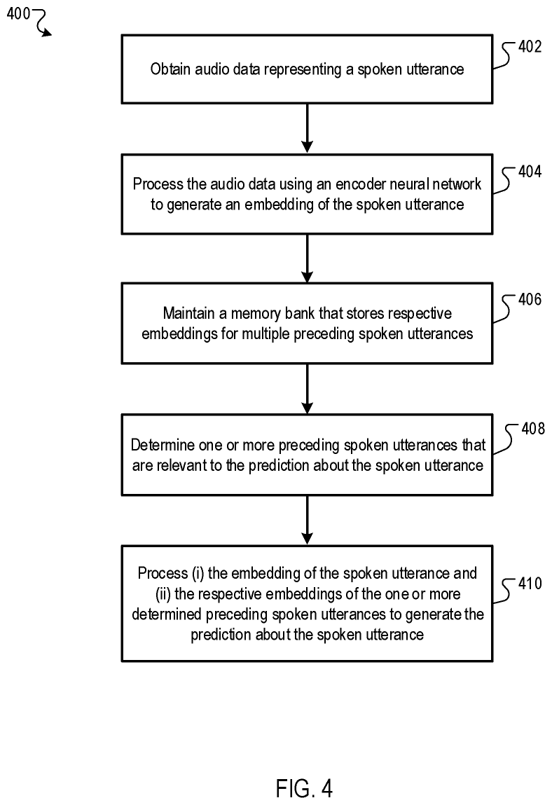

FIG. 4 is a flow diagram of an example process 400 for generating a prediction for a spoken utterance. For convenience, the process 400 will be described as being performed by a system of one or more computers located in one or more locations. For example, a neural network system, e.g., the neural network system 100 described above with reference to FIG. 1, the neural network system 200 described above with reference to FIG. 2, or the neural network system 300 described above with reference to FIG. 3, appropriately programmed in accordance with this specification, can perform the process 400.

The system obtains audio data representing the spoken utterance (step 402). For example, the audio data can be data that includes a sequence of data elements representing the audio signal of the spoken utterance, e.g., where each data element represents a raw, compressed, or companded amplitude value of an audio wave of the spoken utterance. As another example, the spoken utterance can be represented using a spectral representation, e.g., a spectrogram or a MFCC feature representation generated from raw audio data of the spoken utterance. More generally, audio data excludes text data that is generated by speech recognition.

The system processes the audio data using an encoder neural network to generate an embedding of the spoken utterance (step 404). For example, the encoder neural network can be configured similarly to the utterance encoder neural network 110 described above with reference to FIG. 1, the utterance encoder neural network 210 described above with reference to FIG. 2, or the utterance encoder neural network 310 described above with reference to FIG. 3.

The system can then execute steps 406, 408, and 410 to process the embedding of the spoken utterance using a prediction neural network to generate the prediction about the spoken utterance.

In particular, the system maintains, in a memory bank, respective embeddings for multiple preceding spoken utterances that were previously processed by the encoder neural network (step 406). For example, the memory bank can be configured similarly to the utterance memory bank 230 described above with reference to FIG. 2, the short-term utterance memory bank 330 described above with reference to FIG. 3, or the long-term utterance memory bank 350 described above with reference to FIG. 3.

The system determines, using the embedding of the spoken utterance and the respective embeddings of the preceding spoken utterances stored by the memory bank, one or more preceding spoken utterances that are relevant to the prediction about the spoken utterance (step 408). Not all preceding spoken utterances are determined to be relevant; typically, only a proper subset of spoken utterances is selected.

The system processes (i) the embedding of the spoken utterance and (ii) the respective embeddings of the one or more determined preceding spoken utterances to generate the prediction about the spoken utterance (step 410). For example, the system can apply an attention mechanism at one or more respective neural network layers of a prediction neural network, e.g., the prediction neural network 220 described above with reference to FIG. 2 or the prediction neural network 320 described above with reference to FIG. 3.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:
Embodiment 1 is a method comprising:
obtaining audio data representing a spoken utterance;
processing the audio data using an encoder neural network to generate an embedding of the spoken utterance; and
processing the embedding of the spoken utterance using a prediction neural network to generate a prediction about the spoken utterance, the processing comprising:
   maintaining, in a memory bank, respective embeddings for a plurality of preceding spoken utterances that were previously processed by the encoder neural network;
   determining, using the embedding of the spoken utterance and the respective embeddings of the preceding spoken utterances, one or more embeddings of respective preceding spoken utterances that are relevant to generating the prediction about the spoken utterance, wherein the one or more relevant embeddings are a proper subset of the embeddings maintained in the memory bank; and
   processing (i) the embedding of the spoken utterance and (ii) the respective embeddings of the one or more determined preceding spoken utterances to generate the prediction about the spoken utterance.
Embodiment 2 is the method of embodiment 1, wherein the encoder neural network has been configured through training to generate an embedding of the spoken utterance that encodes both (i) lexical features of the spoken utterance and (ii) paralinguistic features of the spoken utterance.
Embodiment 3 is the method of any one of embodiments 1 or 2, wherein processing (i) the embedding of the spoken utterance and (ii) the respective embeddings of the one or more determined preceding spoken utterance to generate the prediction about the spoken utterance comprises applying a cross-attention mechanism between the embedding of the spoken utterance and the respective embeddings of the one or more determined preceding spoken utterance.
Embodiment 4 is the method of any one of embodiments 1-3, wherein the memory bank stores, for each of one or more of the plurality of preceding spoken utterances, one or more unaggregated embeddings generated by the encoder neural network in response to processing the preceding spoken embedding.
Embodiment 5 is the method of any one of embodiments 1-4, wherein maintaining the embeddings for the plurality of preceding spoken utterances comprises storing, in the memory bank and for each of one or more of the plurality of preceding spoken utterances, a respective aggregated embedding that has been generated by performing operations comprising:
processing, by the encoder neural network, the preceding spoken utterance to generate a full embedding of the preceding spoken utterance; and
processing the full embedding of the preceding spoken utterance to generate the aggregated embedding of the preceding spoken utterance, wherein the aggregated embedding has a lower dimensionality than the full embedding.
Embodiment 6 is the method of embodiment 5, wherein:
the full embedding comprises a plurality of embedding elements that each correspond to a respective element of the preceding spoken utterance; and
processing the full embedding of the preceding spoken utterance to generate the aggregated embedding of the preceding spoken utterance comprises combining the plurality of embedding elements.
Embodiment 7 is the method of any one of embodiments 5 or 6, wherein maintaining the embeddings for the plurality of preceding spoken utterances comprises iteratively performing operations comprising:
identifying, from a set of full embeddings stored by the memory bank, one or more full embeddings to aggregate; and
processing the one or more identified full embeddings to generate respective aggregated embeddings.
Embodiment 8 is the method of embodiment 7, wherein identifying, from a set of full embeddings stored by the memory bank, one or more full embeddings to aggregate comprises:
identifying a particular full embedding based on one or more of:
   one or more attention values corresponding to the particular full embedding that were computed during respective executions of the prediction neural network, or
   an amount of time since the full embedding was added to the memory bank.
Embodiment 9 is the method of embodiment 8, wherein identifying a particular full embedding based on one or more attention values corresponding to the particular full embedding that were computed during respective executions of the prediction neural network comprises:
identifying the particular full embedding based on one or more of:
   a measure of central tendency of the one or more attention values corresponding to the particular full embedding, or
   a maximum attention value from the one or more attention values corresponding to the particular full embedding.
Embodiment 10 is the method of any one of embodiments 1-9, wherein maintaining the embeddings for the plurality of preceding spoken utterances comprises iteratively performing operations comprising:
identifying one or more embeddings as candidates for pruning; and
removing the one or more identified embeddings from the memory bank.
Embodiment 11 is the method of embodiment 10, wherein identifying one or more embeddings as candidate for pruning comprises:
identifying a particular embedding based on one or more of:
   one or more attention values corresponding to the particular embedding that were computed during respective executions of the prediction neural network, or
   an amount of time since the embedding was added to the memory bank.
Embodiment 12 is the method of embodiment 11, wherein identifying a particular embedding based on one or more attention values corresponding to the particular embedding that were computed during respective executions of the prediction neural network comprises:
identifying the particular embedding based on one or more of:
   a measure of central tendency of the one or more attention values corresponding to the particular embedding, or
   a maximum attention value from the one or more attention values corresponding to the particular embedding.
Embodiment 13 is the method of any one of embodiments 1-12, wherein maintaining the embeddings for the plurality of preceding spoken utterances comprises:
maintaining embeddings for respective preceding spoken utterances in a plurality of different memory banks that each store embeddings at respective different resolutions.
Embodiment 14 is the method of any one of embodiments 1-13, wherein maintaining the embeddings for the plurality of preceding spoken utterances comprises:
maintaining data representing a graph that includes (i) a plurality of nodes corresponding to respective preceding spoken utterances and (ii) a plurality edges connecting respective nodes, each edge between a first node and a second node representing a relationship between the preceding spoken utterance corresponding to the first node and the preceding spoken utterance corresponding to the second node.
Embodiment 15 is the method of embodiment 14, wherein determining one or more preceding spoken utterances that are relevant to the prediction about the spoken utterance comprises:
determining a first preceding spoken utterance that is relevant to the prediction about the spoken utterance; and
determining a second preceding spoken utterance whose corresponding node in the graph shares an edge with the node corresponding to the first preceding spoken utterance.
Embodiment 16 is the method of any one of embodiments 1-15, wherein the prediction neural network does not process a transcription of the spoken utterance when generating the prediction about the spoken utterance.
Embodiment 17 is the method of any one of embodiments 1-16, wherein one or more of:
the spoken utterance and each preceding spoken utterance were spoken by a same speaker, or
the spoken utterance and each preceding spoken utterance were captured by a same particular device, and the encoder neural network and prediction neural network are executed on the particular device.
Embodiment 18 is the method of any one of embodiments 1-17, further comprising:
maintaining, for each of one or more of the plurality of preceding spoken utterances whose embeddings are stored by the memory bank, audio data representing the preceding spoken utterance,
wherein processing (i) the embedding of the spoken utterance and (ii) the respective embeddings of the one or more determined preceding spoken utterance to generate the prediction about the spoken utterance comprises:
   further processing the respective audio data representing the one or more determined preceding spoken utterances to generate the prediction about the spoken utterance.
Embodiment 19 is a system comprising one or more computers and one or more storage devices storing instructions that when executed by the one or more computers cause the one or more computers to perform the method of any one of embodiments 1-18.
Embodiment 20 is one or more non-transitory computer storage media storing instructions that when executed by one or more computers cause the one or more computers to perform the method of any one of embodiments 1-18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining audio data representing a spoken utterance;
processing the audio data using an encoder neural network to generate an embedding of the spoken utterance; and
processing the embedding of the spoken utterance using a prediction neural network to generate a prediction about the spoken utterance, the processing comprising:
maintaining, in a memory bank, respective embeddings for a plurality of preceding spoken utterances that were previously processed by the encoder neural network;
determining, using the embedding of the spoken utterance and the respective embeddings of the preceding spoken utterances, one or more embeddings of respective preceding spoken utterances that are relevant to generating the prediction about the spoken utterance, wherein the one or more relevant embeddings are a proper subset of the embeddings maintained in the memory bank; and
processing (i) the embedding of the spoken utterance and (ii) the respective embeddings of the one or more determined preceding spoken utterances to generate the prediction about the spoken utterance.

2. The method of claim 1, wherein the encoder neural network has been configured through training to generate an embedding of the spoken utterance that encodes both (i) lexical features of the spoken utterance and (ii) paralinguistic features of the spoken utterance.

3. The method of claim 1, wherein processing (i) the embedding of the spoken utterance and (ii) the respective embeddings of the one or more determined preceding spoken utterance to generate the prediction about the spoken utterance comprises applying a cross-attention mechanism between the embedding of the spoken utterance and the respective embeddings of the one or more determined preceding spoken utterance.

4. The method of claim 1, wherein the memory bank stores, for each of one or more of the plurality of preceding spoken utterances, one or more unaggregated embeddings generated by the encoder neural network in response to processing the preceding spoken embedding.

5. The method of claim 1, wherein maintaining the embeddings for the plurality of preceding spoken utterances comprises storing, in the memory bank and for each of one or more of the plurality of preceding spoken utterances, a respective aggregated embedding that has been generated by performing operations comprising:
processing, by the encoder neural network, the preceding spoken utterance to generate a full embedding of the preceding spoken utterance; and
processing the full embedding of the preceding spoken utterance to generate the aggregated embedding of the preceding spoken utterance, wherein the aggregated embedding has a lower dimensionality than the full embedding.

6. The method of claim 5, wherein:
the full embedding comprises a plurality of embedding elements that each correspond to a respective element of the preceding spoken utterance; and
processing the full embedding of the preceding spoken utterance to generate the aggregated embedding of the preceding spoken utterance comprises combining the plurality of embedding elements.

7. The method of claim 5, wherein maintaining the embeddings for the plurality of preceding spoken utterances comprises iteratively performing operations comprising:
identifying, from a set of full embeddings stored by the memory bank, one or more full embeddings to aggregate; and
processing the one or more identified full embeddings to generate respective aggregated embeddings.

8. The method of claim 7, wherein identifying, from a set of full embeddings stored by the memory bank, one or more full embeddings to aggregate comprises:
identifying a particular full embedding based on one or more of:
one or more attention values corresponding to the particular full embedding that were computed during respective executions of the prediction neural network, or
an amount of time since the full embedding was added to the memory bank.

9. The method of claim 8, wherein identifying a particular full embedding based on one or more attention values corresponding to the particular full embedding that were computed during respective executions of the prediction neural network comprises:
identifying the particular full embedding based on one or more of:
a measure of central tendency of the one or more attention values corresponding to the particular full embedding, or
a maximum attention value from the one or more attention values corresponding to the particular full embedding.

10. The method of claim 1, wherein maintaining the embeddings for the plurality of preceding spoken utterances comprises iteratively performing operations comprising:
identifying one or more embeddings as candidates for pruning; and
removing the one or more identified embeddings from the memory bank.

11. The method of claim 10, wherein identifying one or more embeddings as candidate for pruning comprises:
identifying a particular embedding based on one or more of:
one or more attention values corresponding to the particular embedding that were computed during respective executions of the prediction neural network, or
an amount of time since the embedding was added to the memory bank.

12. The method of claim 11, wherein identifying a particular embedding based on one or more attention values corresponding to the particular embedding that were computed during respective executions of the prediction neural network comprises:
identifying the particular embedding based on one or more of:
a measure of central tendency of the one or more attention values corresponding to the particular embedding, or
a maximum attention value from the one or more attention values corresponding to the particular embedding.

13. The method of claim 1, wherein maintaining the embeddings for the plurality of preceding spoken utterances comprises:
maintaining embeddings for respective preceding spoken utterances in a plurality of different memory banks that each store embeddings at respective different resolutions.

14. The method of claim 1, wherein maintaining the embeddings for the plurality of preceding spoken utterances comprises:
maintaining data representing a graph that includes (i) a plurality of nodes corresponding to respective preceding spoken utterances and (ii) a plurality edges connecting respective nodes, each edge between a first node and a second node representing a relationship between the preceding spoken utterance corresponding to the first node and the preceding spoken utterance corresponding to the second node.

15. The method of claim 14, wherein determining one or more preceding spoken utterances that are relevant to the prediction about the spoken utterance comprises:
determining a first preceding spoken utterance that is relevant to the prediction about the spoken utterance; and
determining a second preceding spoken utterance whose corresponding node in the graph shares an edge with the node corresponding to the first preceding spoken utterance.

16. The method of claim 1, wherein the prediction neural network does not process a transcription of the spoken utterance when generating the prediction about the spoken utterance.

17. The method of claim 1, wherein one or more of:
the spoken utterance and each preceding spoken utterance were spoken by a same speaker, or
the spoken utterance and each preceding spoken utterance were captured by a same particular device, and the encoder neural network and prediction neural network are executed on the particular device.

18. The method of claim 1, further comprising:
maintaining, for each of one or more of the plurality of preceding spoken utterances whose embeddings are stored by the memory bank, audio data representing the preceding spoken utterance,
wherein processing (i) the embedding of the spoken utterance and (ii) the respective embeddings of the one or more determined preceding spoken utterance to generate the prediction about the spoken utterance comprises:
further processing the respective audio data representing the one or more determined preceding spoken utterances to generate the prediction about the spoken utterance.

19. A system comprising one or more computers and one or more storage devices storing instructions that when executed by the one or more computers cause the one or more computers to perform the method of claim 1.

20. One or more non-transitory computer storage media storing instructions that when executed by one or more computers cause the one or more computers to perform the method of claim 1.
